(19) United States
(12) Patent Application Publication
(10) Pub. No.: US 2004/0101141 A1
(43) Pub. Date: May 27, 2004

(54) System and method for securely installing a cryptographic system on a secure device

(76) Inventor: Jukka Alve, Helsinki (FI)

Correspondence Address: MORGAN & FINNEGAN, L.L.P., 345 Park Avenue, New York, NY, 10154-0053, US

(21) Appl. No.: 10/305,474

(22) Filed: Nov. 27, 2002

(51) Int. Cl. H04L 9/00

(52) U.S. Cl. 380/278

(57) ABSTRACT

The present invention discloses a system and method for the secure installation of a cryptographic system on distributed devices. The system employs a secure device with a device ID, secure processing environment, and a cryptographic key. The secure device communicates with a cryptographic system provider. The cryptographic system provider employs a shared secret between itself and the secure device to ensure the secure transmission and installation of the cryptographic system.

### BACKGROUND OF THE INVENTION

Digital Rights Management (DRM) has become a serious priority for content creators in our ever more interconnected world. Digitized media is easy to reproduce and distribute, two qualities that threaten to greatly devalue copyright holders' work. The pervasive adoption of digital technologies has created a push among content creators and technology companies to create DRM systems that prevent the unrestricted copying and distribution of copyrighted works. Ideally, a widely adopted DRM standard will be developed because that will allow consumers the broadest and most unfettered access to their digitized content, while allowing copyright holders to maintain their commercial interests. With a widely adopted standard users will be able to access their digitized content on various devices made by different companies. Efforts are ongoing to create such a standard.

Until a DRM standard is finalized, hardware manufacturers face a problem when designing content use-and-render devices. Without a standard in place, hardware manufacturers risk producing devices that will be incompatible with the chosen DRM standard. These devices would become obsolete with the introduction of a standard, thus, compatibility with the eventual standard is important to producing marketable devices. Producing devices that are compatible with future standards has the added advantage that it will create an installed user base for DRM protected content. Having an installed user base, ready to implement the DRM standard, will help support the standard as it gains widespread acceptance.

### SUMMARY OF THE INVENTION

The above identified problems are solved and a technical advance is achieved in the art by providing a system and method for securely installing a cryptographic system on a secure device.

DRM systems protect content and ensure it is used in a proper way. Usually, DRM systems use cryptographic keys to encrypt and protect content. The DRM standard will, most likely, implement a public key cryptographic (PKC) system. In such a DRM system the private key must remain secret, not only from third parties but also from the users themselves. Secrecy is, therefore, achieved by keeping the secret information inside the secure device and inaccessible to users of the secure device. If the private key was accessible to users in an unprotected form, copyists could use the key to defeat the DRM system. Therefore, once the devices are released to the public, they can only be updated using techniques that insure the secrecy of the private key. This can be accomplished in accordance with the present invention by building devices that contain resources that can later be used to ensure the secure transmission and installation of a cryptographic system, such as the DRM standard.

An exemplary embodiment of the present invention employs a secure device communicating with a cryptographic system provider. The secure device has a unique device ID, a secret cryptographic key, and a secure processing environment. The cryptographic system provider has access to a list that can be used to derive a device's secret cryptographic key from its unique device ID. The cryptographic system provider can, therefore, use the device's secret cryptographic key to encrypt the private key of a cryptographic key pair, or other secret information, e.g. a cryptographic symmetric key, of any installed cryptographic system. The secure device receives and stores the encrypted cryptographic key. When the cryptographic key needs to be used, the encrypted version will be copied into the protected processing environment. There it will be decrypted, with the device's secret cryptographic key, and used to practice the DRM system, while being kept secret from potential copyists.

Another aspect of the present invention installs software to check the integrity of the secure device prior to the transmission of any secret information. This is accomplished by transmitting software to the secure device that checks for tampering within the secure device. The results of the check can then be transmitted to the cryptographic system provider for verification. If the cryptographic system provider detects tampering, it can refuse to transmit sensitive information to that device.

Another aspect of the present invention guards against tampering by reinstalling any security sensitive software at the time of the transmission of the encrypted cryptographic key. By freshly installing critical software, any modified or otherwise tampered with software is overwritten, deleted, or not used. This will neutralize attempts to use modified software to defeat the cryptographic system.

Another embodiment of the present invention avoids the need to protect the secrecy of the device specific cryptographic key installed on the secure device. Instead, the integrity of cryptographic system is maintained by providing a set of global secret keys, which are the same for many devices. A device specific key is still used but it is only unalterably stored in insecure memory without any special efforts to ensure its secrecy. Instead, one of the global secret keys is used as the primary source of security with the device specific key providing authentication and supplemental security. To practice this embodiment the cryptographic system provider encrypts the cryptographic key, e.g. the private key of a cryptographic key pair with both the device specific key and one of the global secret keys. The double encrypted cryptographic key is then transmitted to the secure device along with a global key identifier, which tells the secure device which global key was used for encryption. When the cryptographic key needs to be used, it will be copied into the secure processing environment, where it will be decrypted with both the device specific key and the global key indicated by the global key identifier. Of course, the secure processing environment will keep the cryptographic key secret as it is decrypted and used.

Another embodiment of the present invention uses a similar technique but avoids the need to transmit the global key identifier. Instead, the secure device attempts to decrypt the cryptographic key with each of the global secret keys in succession. After each decryption, the secure device tests the resulting decrypted cryptographic key by using it to decrypt a test message encrypted with either the decrypted cryptographic key or, if a cryptographic key pair is used, with the other key in the cryptographic key pair. If the decrypted test message is identical to the plain text version of the test message then the correct global secret key was used and the cryptographic key is correct. Otherwise, the same process must be completed with the other global keys until the true cryptographic key is determined.

The test message used for key determination can be derived from a variety of sources. In one embodiment of the invention, the encrypted test message is delivered to the device by the cryptographic system provider either separately or with the delivery of the encrypted cryptographic key. In another embodiment, the plain text version of the test message is delivered to the device, either separately or with the delivery of the cryptographic system. Still in another embodiment of the invention, the plain text version of the test message is stored in the device when the device is manufactured. In an embodiment using public/private key pairs, the test message can be generated by the device itself, encrypted with the public key, and decrypted with each of the potential private keys until the plain text message is revealed, thereby, identifying the correct key.

The various embodiments of the invention can be used in different content distribution and rendering environments, e.g. in broadcast or multiple environments, in IP data casting systems, and the devices may be DVB-T receivers, set-top boxes or mobile handsets.

Other and further aspects of the invention will become apparent during the course of the description and by reference to the attached drawings.

### BRIEF DESCRIPTION OF THE FIGURES

FIG. 1 is a block diagram illustrating the components and operation of an exemplary embodiment of the present invention.

FIG. 2 is a block diagram illustrating the components and operation of another exemplary embodiment of the present invention.

FIG. 3 is a block diagram illustrating the components and operation of another exemplary embodiment of the present invention.

### DETAILED DESCRIPTION

The present invention provides a system and method for the secure installation of a cryptographic system onto a device that has left the control of the manufacturer. The implementation of the present invention requires content use-and-render devices to be constructed with certain security components. These components can later be used to ensure the secure installation of the cryptographic system.

Secure content use-and-render devices could be embodied by any device that will use or render DRM protected content, examples include cellular phones, personal digital assistants, general purpose computers, personal media devices, set top boxes, home theater or audio components, etc. A secure device requires a unique device ID, a secret cryptographic key, and a secure processing environment. The cryptographic key must be kept secret from the users of the device because exposure of the key would enable a copyist to compromise the device and any later installed cryptographic system. The secure processing environment performs computational functions required by the cryptographic system, including, encrypting, decrypting and key storage. The secure processing environment can perform its functions without exposing sensitive information to copyists intent on defeating the cryptographic system.

Installation of a cryptographic system on a secure device is achieved by communicating with a cryptographic system provider. A party interested in maintaining the security of the system would act as the cryptographic system provider. The cryptographic system provider might be the secure device manufacturer, the content provider, a third party service that maintains the standard, or others. Physically, the cryptographic system provider can be embodied by software running on a server computer, or split up among various server computers. The cryptographic system provider maintains a key look-up that stores a copy of the devices' secret keys. Using a device's secret key it can securely transmit the cryptographic system to be installed on the secure device. The responsibilities of the cryptographic system provider could also be split amongst multiple parties. For example, individual device manufacturers might maintain the key look-up for the devices that they produced, while content providers perform software installations and maintain the security and compatibility of the system.

The communication between the secure device and the cryptographic system provider can be accomplished using any known method. Including, for example, wired and wireless transmission using any type of connection or communications protocol. A wireless network connection using TCP/IP is one example of a communication link that could be used to practice the invention.

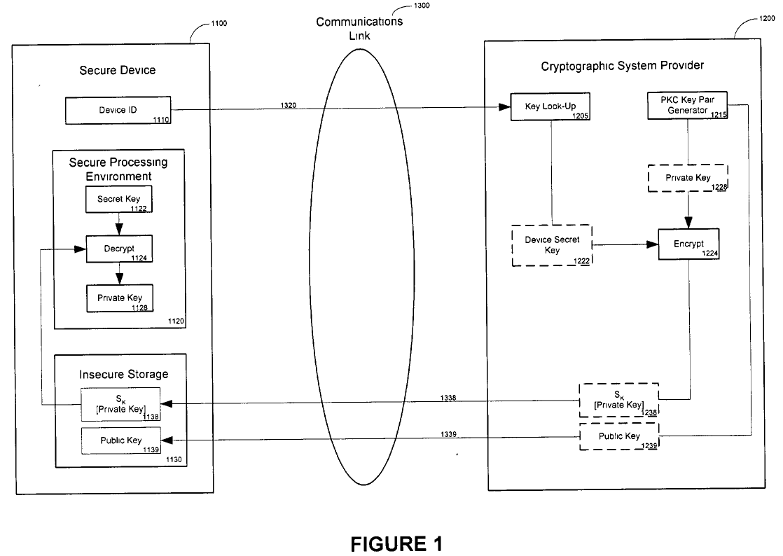

FIG. 1 provides a detailed block diagram illustrating an exemplary embodiment of the present invention. This block diagram demonstrates both the apparatuses used to practice the present embodiment and the steps preformed during cryptographic system installation. The present system comprises secure device 1100, cryptographic system provider 1200, and communications link 1300.

Secure device 1100 provides a device ID 1110, insecure storage 1130, secret key 1122, and a secure processing environment 1120. The device ID 1110 provides a unique identification for a particular secure device, as a mere identifier it does not require any encryption or security. The device ID 1110 can be stored on the device, or programmed into the device in any suitable location, e.g., CPU, flash memory, ROM, ASIC, hard disk, etc.

The insecure storage 1130 represents writable non-volatile memory contained on the device. It is considered insecure because it is not specially protected from a copyist's attempts to gain access to the information stored on the device. Physically, the insecure storage can be any writable device, such as a hard disk, flash memory, PROM, etc.

Secret key 1122 is a cryptographic key that represents a shared secret between the secure device and the cryptographic system provider. The secret key is useful for both secure transmission of the cryptographic system and authentication of the secure device. The authentication aspect is provided by the fact that the secret key is only associated with one device ID, therefore, only the intended target device can decrypt the secret information. This ensures that, so long as the secret key remains secret, only the target device will have access to the secret information. Similarly, encryption also ensures that the cryptographic system's secret information will not be accessible in transit between the cryptographic system provider and the secure device or when stored in the device's insecure memory. The secret key can be embodied with a symmetric key for use with any known symmetric encryption algorithm such as AES, 3DES, etc. Symmetric algorithms have the advantage of being fast and efficient for both creating keys and encrypting/decrypting data.

Secure processing environment 1120 provides the ability to decrypt protected keys without divulging the clear version of the key. Many methods for securing a processing environment are known in the art. For example, secure processing environments can be created on specialty processors in which all secure components are included on a single silicone chip. This is secure because determining the internal signals on silicone requires a high level of technical expertise and expensive specialized equipment. Other types of processing environments are secured with tamper detection circuitry that erases secrets when tampering is detected. Another approach is to physically protect the circuitry by encasing it in epoxy. If a low level of security is acceptable, general purpose processors can be used such that any secure information is processed in supervisory mode. The type of secure processing environment used along with the present invention is, ultimately, a business decision based on a balancing of equipment costs and the desired level of security. Thus, the details of any particular secure processing environment are not important to the present invention.

In this particular embodiment the device specific secret key is programmed into the hardware that embodies the secure processing environment.

The process begins when the device ID is transmitted 1320 to the cryptographic system provider 1200 as part of the request for a new cryptographic system. The device ID is used in a key look-up 1205 to determine the device secret key that is stored in the requesting device. The key look-up can be embodied by a simple database correlating device IDs with secret keys. Once found the device's secret key can be used to protect sensitive parts of the cryptographic system transmitted to the secure device. It is worth noting that no special security is described with reference to the cryptographic system provider. This is because the cryptographic system provider wants to ensure the security of their system and, therefore, can be trusted to ensure that sufficient security precautions are put in place.

Assuming the cryptographic system is based on public key—asymmetric—cryptography, examples of which include RSA and ElGamal, the cryptographic system will generate a public/private key pair 1228, 1239 via the PKC key pair generator 1215. This element can be embodied by a software algorithm used to generate keys for the chosen encryption algorithm. Or, this element could comprise a pre-compiled list of keys.

To ensure the security of the system, public key cryptographic systems require that the private key be kept secret. This is accomplished by encrypting the private key with the device specific secret key derived from the key look-up. As shown in FIG. 1, the copy of the device specific key for the requesting device 1222 is used to encrypt 1224 private key 1228. Obviously, if a different type of cryptographic system was used different information would need to be encrypted. Once encrypted, private key 1238 is secure and it can be transmitted 1338 through insecure channels of communication to the secure device. Because it is encrypted, the private key can be stored in the insecure storage 1130 of the secure device, shown as 1138 in FIG. 1. This is advantageous because it avoids a need for specially secured non-volatile writeable memory on the secure device. The cryptographic system provider may also send the public key 1239 to the secure device. Of course, being public no encryption is required during transmission 1339 and storage 1139 of the public key. It should be noted that the public key does not need to be stored on the secure device at all. In the alternative, it could be stored on a server that would be accessible to the parties that send encrypted content to the secure device.

The security of the system relies primarily on maintaining the secrecy of the private keys. Accordingly, the focus of the present invention relies on the integrity of the private key during transmission and installation. However, an additional degree of security can be provided by installing software on the secure device to check its integrity. As noted above, the cryptographic system provider can, and most likely will, send not just the cryptographic keys but, also, software to carry out the cryptographic system. Software routines can be included to check whether any security critical aspects of the device have been compromised. This can be accomplished in a variety of ways. For example, prior to transmission of secret information the system provider can transmit software to the device that checks the hardware and software of the device and reports the results. This would be especially useful if the device contains security critical software modules. In such a case, the integrity testing software could run the secure device's security critical software modules through a hash function. The results from the hash function could be checked against expected values by the cryptographic system provider. Any tampering would result in a mismatch of the values. This mismatch would alert the cryptographic system provider not to send sensitive information to that secure device.

Using another approach, the system provider could update all crucial software during the cryptographic system installation process. In this way, any security critical code that has been tampered with will be written over, deleted, and not used, with the new security system. Thus, any attempts made by copyists to alter critical software would be frustrated.

Returning, to FIG. 1, with the encrypted private key, and any other required software (not shown), installed on the secure device, the secure device may now use the new cryptographic system. Using the new system will require accessing the clear version of encrypted private key 1138. To do so, the secure device reads the encrypted version of the key into the secure processing environment. The secret key 1122 is used to decrypt 1124 the encrypted private key 1138. Once decrypted, the clear private key 1128 may be used within the secure processing environment to carry out functions required by the cryptographic system.

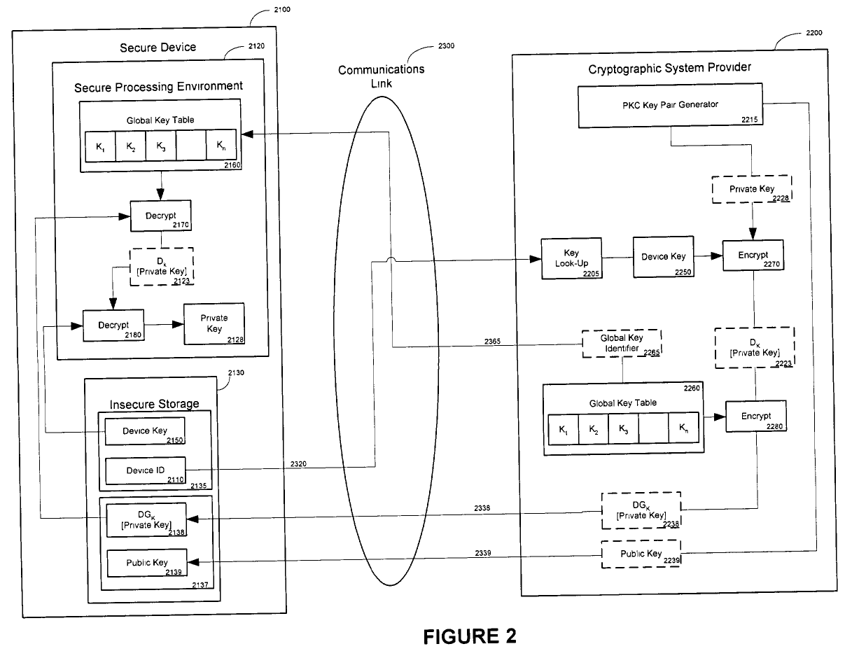

FIG. 2 shows another exemplary embodiment of the present invention. This embodiment also employs a secure device 2100, a cryptographic system provider 2200, and a communications link 2300. These elements are generally the same as described in the previous embodiment, except as discussed below.

The key difference between this embodiment and the previous embodiment is the way the shared secrets of the devices are maintained. As described above, the previous embodiment relies on a unique secret key programmed into each secure device. Manufacturing hardware with individualized secrets may prove too costly or impractical. FIG. 2 describes a way of practicing the disclosed invention with hardware that does not need an individualized secret key.

Instead of using hardware with individualized secrets, FIG. 2 describes the use of global secret keys that would be the same for a number of devices. This embodiment would not suffer from the costs, or engineering difficulties, associated with manufacturing devices with individualized secret keys. Instead, this embodiment can take advantage of the efficiencies provided by creating a number of identical devices.

Of course, all secure devices do not need to have exactly the same set of global secret keys. For example, different manufacturers, or different groups of devices, might have different global secret keys. Practical considerations can determine which devices share global secrets. In any case, the cryptographic system provider must know which set of global secrets are being used by a particular requesting device. For the sake of simplicity, this example assumes there is only one set of global secrets.

The secure device still has a device specific key 2150 in this embodiment. The device specific key, however, is only stored on insecure unalterable storage 2135, for example a PROM. Storing the device specific key on insecure storage greatly simplifies device manufacture because the key can simply be written to the storage device, rather than securely built into the hardware, as is done with the secret keys. Because it is kept in insecure storage, the device specific key alone cannot be relied on to ensure strict secrecy of the cryptographic system. Instead the device specific key mainly provides the authentication functions described in the previous embodiment, while providing nominal additional security.

The present embodiment ensures a sufficient level of security by employing a set of secret global keys 2160, as discussed above. Generally, the use of a single global key has a disadvantage in that a copyist only needs to defeat the security of one device to render all devices sharing the global key unprotected. In contrast, if a copyist were to defeat the security of a secure device with a unique secret key, as described in the previous embodiment, the failure of security and associated losses are limited to that one device.

The system employed by the present embodiment mitigates the risks associated with global secrets in two ways. First, the secret information is double encrypted, both with a global key and the device specific key. This additional level of complexity increases the effort required to reveal any secret information. For example, the use of the device specific key prohibits potential copyists from compromising the device by recording and playing back the data traffic used to legitimately install the security system on another device. Second, a full set of global keys are present on the device, only one of which is used for the encryption. This allows different devices, or different transactions, to use different keys. This will be useful for confusing copyists attempting to disable the cryptographic system. For example, if they are able to reveal one global key all of the transactions that used a different global key remain secure. Also, using multiple global keys reduces the amount of available information that copyists can use to crack the secret keys and generally adds an extra element of confusion for those trying to crack the cryptographic system.

The process of installing the cryptographic system begins with the secure device sending a request 2320 for a cryptographic system, along with the device's unique device ID 2110, over communications link 2300 to the cryptographic system provider 2200. The cryptographic system provider prepares the cryptographic system software for the requesting device, and derives a unique public/private key pair 2228, 2239 using PKC key Pair Generator 2215. The key look-up 2205 is used to determine the requesting device's device key. The device key 2250 is used to encrypt 2270 the private key 2228, the encrypted key is represented as --Dₖ[Private Key] 2223. Next, one of the global secret keys is chosen from the global key table 2260. The global key derived from the table is used to encrypt 2280 the private key for a second time resulting in DGₖ[Private Key] 2238. This encrypted key is then transmitted 2338 to the secure device over communications link 2300. The device's public key 2239 and a global key identifier 2265 are also sent 2339, 2365 to the secure device. The global key identifier is used by the secure device to determine which global secret key should be used to decrypt the private key.

With the encrypted private key installed on the secure device, the secure device may now use the new cryptographic system. Using the new system will require accessing the private key. To do so, the secure device uses the global key identifier to determine the appropriate global key to use from the global key table 2160. The encrypted version of the key is read into the secure processing environment and decrypted 2170 with the appropriate global secret key, resulting in Dₖ[Private Key] 2123. Then the device key 2120 is read into the secure processing environment and used to perform the second decryption 2180 of the private key. The second decryption results in a clear private key 2128, which can be used to practice the cryptographic standard.

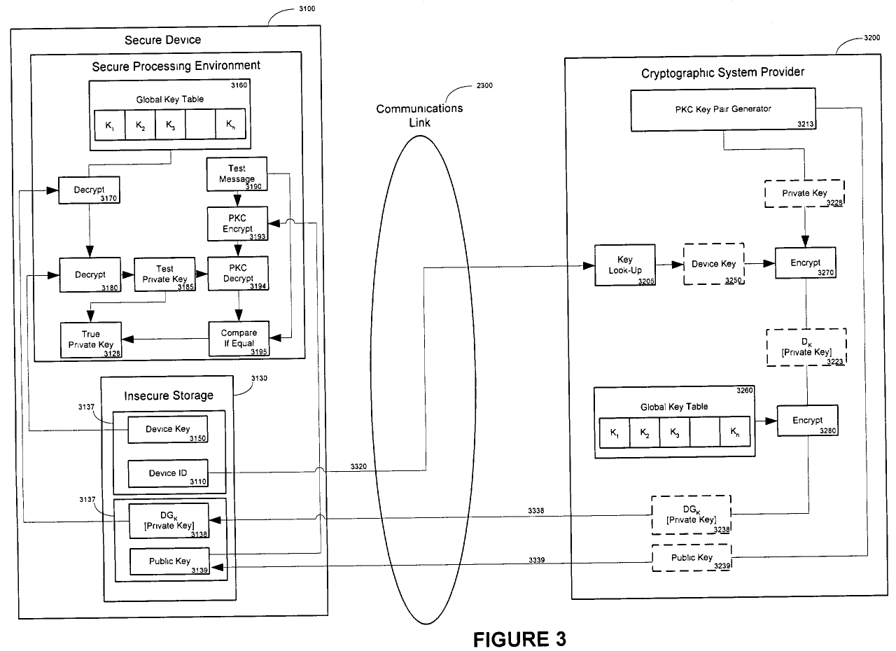

FIG. 3 shows a variation of the embodiment of FIG. 2. In particular, FIG. 3 shows a system and method for practicing the invention using global secret keys without transmitting a global key identifier. The global key identifier, which tells the secure device which global key to use to decrypt the transmitted secret key, may be useful to copyists trying to crack the encryption system. For example, if the global identifier was discovered it would alert copyists that multiple keys were being used. Using the embodiment of FIG. 3 it not necessary to transmit the global key identifier.

The process according to the FIG. 3 embodiment begins with the secure device 3100 sending a request 3320 to the cryptographic system provider 3200, including the secure device's device ID 3110. The cryptographic system provider performs functions identical to the cryptographic system provider of FIG. 2, except in the FIG. 3 embodiment no global key identifier is sent to the secure device.

The secure device receives the encrypted private key, DGₖ[Private Key] 3138, and the public key 3139. Because no global key identifier is provided, the secure device of FIG. 3 attempts to decrypt the private key with each of the global secret keys until a successful result is achieved. The process begins by loading the encrypted private key into the secure processing environment and decrypting 3170 it with the first global secret key chosen from the global key table 3160. The result of that decryption is then decrypted 3180 again with the device key 3150. This process results in a test private key 3185.

Next, a process is used to determine if the test private key is correct. A test message 3190 is encrypted 3193 with the public key 3139. The result of that operation is then decrypted 3194 using the test private key 3185. The result of that decryption is then compared 3195 to the original test message 3190. If the result is identical to the initial test message, it is confirmed that the test private key is the true private key 3128. If the result of the comparison is not identical to the initial test message, the wrong global secret key was used and the process must be preformed again with the next global secret key. This process is repeated and eventually the secure device will decrypt the private key with the same global key used by the cryptographic system provider. With the true private key determined the secure device can practice the installed cryptographic standard.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact instruction and operation illustrated and described herein. Accordingly, all suitable modifications and equivalents that may be resorted to are intended to fall within the scope of the claims.

1. A method for securely distributing a cryptographic system comprising:
associating a unique device ID and a first secret cryptographic key;
storing the unique device ID and the first secret cryptographic key in a key look-up;
storing the unique device ID and the first secret cryptographic key on a device, wherein the first secret cryptographic key is securely stored;
receiving a request for a cryptographic system comprising the unique device ID;
accessing the key look-up to retrieve the first secret cryptographic key associated with the unique device ID;
encrypting a second cryptographic key with the retrieved first secret cryptographic key; and
transmitting the encrypted second cryptographic key to the device.

2. The method of claim 1, wherein the first secret cryptographic key is a device specific key.

3. The method of claim 1, wherein the first secret cryptographic key is one of the following: a symmetric cryptographic key or a private cryptographic key of a cryptographic key pair.

4. The method of claim 1, further comprising:
storing the unique device ID and the first secret cryptographic key in unalterable memory in a device.

5. The method of claim 1 further comprising:
encrypting the encrypted first secret cryptographic key with one global secret key from a set of global secret keys.

6. The method of claim 1, further comprising transmitting software associated with the cryptographic system.

7. The method of claim 1, further comprising:
transmitting verification software to the device prior to transmitting the encrypted second cryptographic key;
receiving verification data from the device;
comparing the verification data and an expected response; and
wherein the encrypted second cryptographic key is only transmitted if the verification data matches the expected response.

8. The method of claim 1, further comprising:
transmitting security software along with the encrypted second cryptographic key, wherein the security software reinstalls new copies of any sensitive software.

9. The method of claim 1, further comprising transmitting a global key identifier to the device.

10. A method for securely installing a cryptographic system on a secure device comprising:
requesting a cryptographic system, wherein the request includes a unique device ID;
receiving a second cryptographic key encrypted at least partly with a first secret cryptographic key at the secure device;
storing the encrypted second cryptographic key in an insecure storage;
decrypting the encrypted second cryptographic key, with the first secret cryptographic key, in a secure processing environment; and
using the decrypted second cryptographic key to practice the cryptographic system.

11. The method of claim 10, wherein the first secret cryptographic key is a device specific key.

12. The method of claim 10 further comprising:
receiving at the secure device a global key identifier; and
using the global key identifier to identify a global key.

13. The method of claim 12, wherein the received second cryptographic key encrypted with the first secret cryptographic key is further encrypted with a third secret cryptographic key.

14. The method of claim 13 further comprising:
decrypting the received second cryptographic key, with the third secret key, in a secure processing environment, wherein the first secret cryptographic key is a device specific key and the third secret key is the identified global key.

15. The method of claim 10 further comprising:
receiving a fourth cryptographic key; and
storing the received fourth cryptographic key in the insecure storage.

16. The method of claim 15, wherein the second cryptographic key is a private key of a key pair and the fourth cryptographic key is a public key of the said key pair.

17. The method of claim 16 further comprising:
decrypting the received second cryptographic key, with a first global key selected from a global key set, in a secure processing environment;
testing the decrypted second cryptographic key;
if the testing step fails, repeating the decrypting and testing steps with another global key from the global key set.

18. The method of claim 10 further comprising installing software associated with the cryptographic system.

19. The method of claim 10 further comprising:
receiving and installing security verification software;
running the verification software and transmitting its results to the cryptographic system provider; and
wherein the transmission of the security verification software results occurs prior to the receipt of the encrypted second cryptographic key.

20. The method of claim 16 wherein the testing step comprises:
using the public key to encrypt a test message;
using the decrypted private key to decrypt the encrypted test message;
determining whether the test message has been changed by the encryption and decryption, if it has changed the test is a failure, if it is the same the test is a success.

21. A device for operating a cryptographic system, the device comprising:
communication means for communicating through a communications link to at least one cryptographic system provider;
a secure processing environment comprising:
a storage means for securely storing one or more cryptographic keys;
decryption means for decrypting encrypted cryptographic keys with the stored cryptographic keys;
means for encrypting and decrypting a test message;
storage means for storing an encrypted cryptographic key, a public cryptographic key of a cryptographic key pair, a unique device identifier, a device specific cryptographic key; and
means for receiving, installing and executing security verification software.

22. A system for distribution of a cryptographic system comprising:
a cryptographic system provider for distributing, in response to a request for a cryptographic system, a cryptographic system comprising:
one or more distributed cryptographic keys;
one or more of identifiers of cryptographic keys;
wherein the request for the cryptographic system comprises a unique identifier of a device to receive the cryptographic system;
wherein the cryptographic system provider uses the unique identifier to determine a device specific cryptographic key associated with the device, the cryptographic system provider further having means for encrypting, prior to distribution, at least one of the distributed cryptographic keys with the device specific cryptographic key;
a device for operating a cryptographic system having means for communicating with the cryptographic system provider through a communications link for receiving the requested cryptographic system, the device further having means for installing and executing the received cryptographic system.
